(19) United States
(12) Patent Application Publication
(10) Pub. No.: US 2006/0069686 A1
(43) Pub. Date: Mar. 30, 2006

(54) System and method for predicting availability

(75) Inventors: William J. Beyda, Cupertino, CA (US); Rami Caspi, Sunnyvale, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Information and Communication Networks, Inc.

(21) Appl. No.: 10/957,141

(22) Filed: Sep. 30, 2004

(51) Int. Cl. G06F 17/30

(52) U.S. Cl. 707/10

(57) ABSTRACT

A telecommunications system includes a network (202); a plurality of client devices (212) operably coupled to said network, said plurality of client devices adapted to select one or more of others of said plurality as contacts on a contact list (404); a presence server (204) coupled to said network and adapted to monitor presence status of selected ones of said others, wherein said presence server maintains one or more records of past presence data for said selected ones; a calendar server (1304) adapted to maintain a calendar for selected ones of said plurality; and a scheduler (1306) adapted to receive said one or more records and said calendar and determine a likely presence status at a predetermined time.

### CROSS REFERENCE TO RELATED APPLICATIONS

The present invention is related to co-pending, commonly assigned U.S. patent application Ser. No. ______, titled SYSTEM AND METHOD FOR HISTORICAL PRESENCE MAP, filed concurrently herewith.

### BACKGROUND OF THE INVENTION

1. Field of the Invention

The present invention is directed generally to telecommunications systems and, particularly, to improvements in providing presence information.

2. Description of the Related Art

Presence-based communications applications are entering the mainstream telecommunications environment. In such applications, a user maintains one or more “contact lists” of other parties whose presence status is to be monitored and displayed to the user. If the other party is determined to be “present,” the user's contact list will display the available status. The user can then contact the other party.

However, while contact lists are typically used to provide the user a current status of other parties, it is often the case that a user will wish to plan a call or conference at a certain future date. Current presence systems, however, do not provide such prospective presence information.

As such, there is a need for an improved system and method for contact list management. There is a still further need for a system and method for using presence information to determine a future schedule.

### SUMMARY OF THE INVENTION

These and other drawbacks in the prior art are overcome in large part by a system and method according to embodiments of the present invention.

A telecommunications system according to an embodiment of the present invention includes a network; a plurality of client devices operably coupled to said network, said plurality of client devices adapted to select one or more of others of said plurality as contacts on a contact list; a presence server coupled to said network and adapted to monitor presence status of selected ones of said others; wherein said presence server maintains one or more records of past presence data for said selected ones and is configured to provide said one or more records to a requesting one of said plurality.

A telecommunications system according to an embodiment of the present invention includes a network; a plurality of client devices operably coupled to said network, said plurality of client devices adapted to select one or more of others of said plurality as contacts on a contact list; a presence server coupled to said network and adapted to monitor presence status of selected ones of said others, wherein said presence server maintains one or more records of past presence data for said selected ones; a calendar server adapted to maintain a calendar for selected ones of said plurality; and a scheduler adapted to receive said one or more records and said calendar and determine a likely presence status at a predetermined time.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 illustrates a multi-modal presence system according to embodiments of the present invention.

FIG. 2 is a block diagram of a telecommunications system according to an embodiment of the present invention.

FIG. 3 is a block diagram of a multimedia server according to embodiments of the present invention.

FIG. 4-FIG. 5 are diagrams of a graphical user interfaces according to embodiments of the present invention.

FIG. 6 is a simplified block diagram of a system according to embodiments of the present invention.

FIG. 7-FIG. 9 are a diagrams illustrating graphical user interfaces for use with a system according to embodiments of the present invention.

FIG. 10-FIG. 13 are flowcharts illustrating operation of embodiments of the present invention.

FIG. 14 is a diagram illustrating a graphical user interface for use with a system according to embodiments of the present invention.

FIG. 15 and FIG. 16 illustrate schedule prediction according to embodiments of the present invention.

FIG. 17 is a flowchart illustrating operation of an embodiment of the present invention.

### DETAILED DESCRIPTION OF EMBODIMENTS OF THE INVENTION

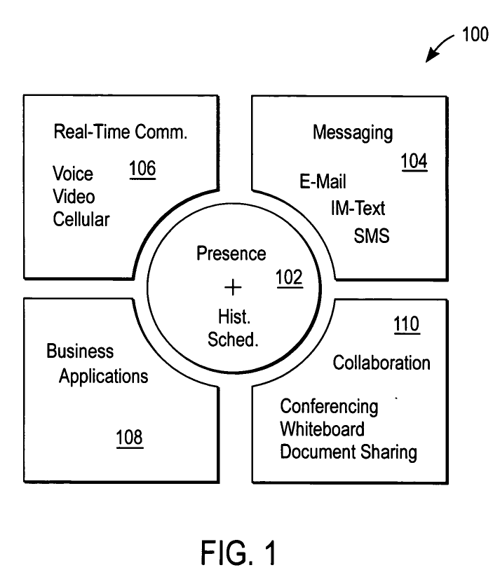

Turning now to the drawings and, with particular attention to FIG. 1, a diagram schematically illustrating a multi-modal presence-based telecommunications system 100 according to an embodiment of the present invention is shown., The telecommunications system 100 includes real-time communication capabilities 106, messaging capabilities 104, network business applications 108, and collaboration applications 110. Real-time communication 106 can include, for example, voice, video, or cellular. Messaging 104 includes e-mail, instant messaging, short messaging service (SMS) or other text-based services. Business applications 108 can include, for example, Customer Relationship Management (CRM) and Enterprise Resource Planning (ERP) software packages. Collaboration applications 110 can include conferencing, whiteboarding, and document sharing applications.

In addition, a multi-modal presence feature 102 according to embodiments of the present invention can provide presence services, including history, and scheduling information, aggregated across the various media 104, 106, 108, 110. More particularly, as will be explained in greater detail below, the presence system 102 can monitor one or more user contact lists for specified presence or availability and provide a historical presence feature wherein the presence server will record a presence status history of registered parties (i.e., will provide a record of past presence data). The histories are accessible by selected users to determine an optimal contact time and/or medium. Still other embodiments of the present invention provide a scheduler that can access the presence status histories of other parties and the requesting user. The scheduler can then determine a projected optimal contact time based on minimizing conflicts in the schedules and projected schedules.

It is noted that while illustrated as a multi-modal presence system, the teachings of the present invention are equally applicable to system employing only single presence-based media. Thus, the figures are exemplary only.

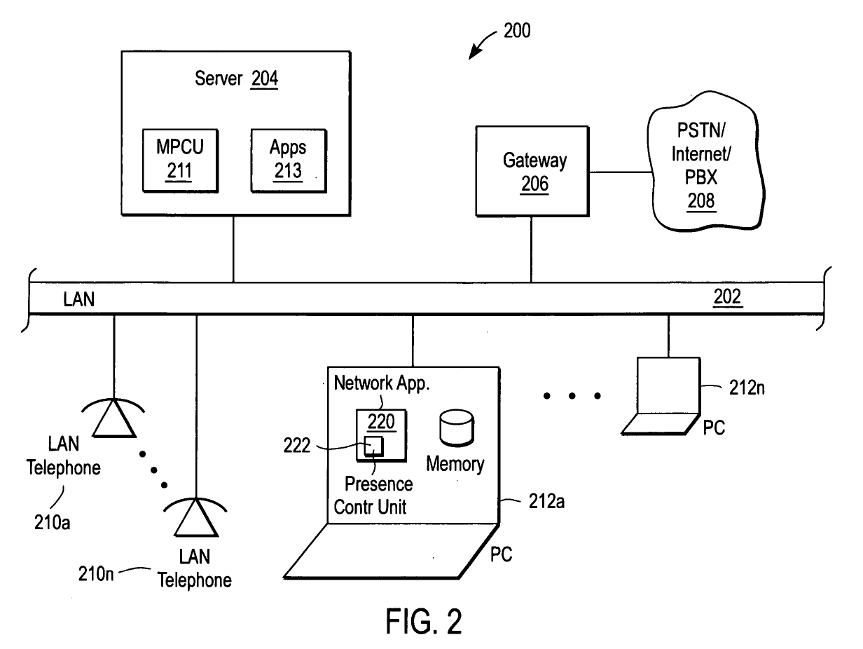

FIG. 2 illustrates an exemplary enterprise network 200 including a presence system in accordance with embodiments of the present invention. It is noted that, while a particular network configuration is shown, the invention is not limited to the specific embodiment illustrated. As shown, the enterprise network 200 includes a local area network (LAN) 202. The LAN 202 may be implemented using a TCP/IP network and may implement voice or multimedia over IP using, for example, the Session Initiation Protocol (SIP) or ITU Recommendation H.323. Coupled to the local area network 102 is a multimedia enterprise or presence server 204.

The server 204 may include one or more controllers (not shown), such as one or more microprocessors, and memory for storing application programs and data. As will be explained in greater detail below, the server 204 may provide a variety of services to various associated client devices, including computers, telephones, personal digital assistants, text messaging units, and the like. Thus, as will be explained in greater detail below, the server 204 may implement suite of applications 213 as well as, or including, a master presence control unit 211, according to embodiments of the present invention.

Also coupled to the LAN 202 is a gateway 206 which may be implemented as a gateway to a private branch exchange (PBX), the public switched telephone network (PSTN) 208, or any of a variety of other networks, such as a wireless, PCS, a cellular network, or the Internet. In addition, one or more client endpoints such as LAN or IP telephones 210a-210n or one or more computers 212a-212n may be operably coupled to the LAN 202.

The computers 212a-212n may be personal computers implementing the Windows XP operating system and thus, running Windows Messenger client (It is noted, however, that other Instant Messaging Programs could be implemented.). In addition, the computers 212a-212n may include telephony and other multimedia messaging capabilities using, for example, peripheral cameras, microphones and speakers (not shown) or peripheral telephony handsets. In other embodiments, one or more of the computers may be implemented as wireless telephones, digital telephones, or personal digital assistants (PDAs). Thus, the figures are exemplary only. The computers 212a-212n may include one or more processors, such as Pentium-type microprocessors, and storage for applications and other programs. The computers 212a-212n may implement network application programs 220 including one or more presence control units 222 in accordance with embodiments of the present invention. In operation, as will be explained in greater detail below, the presence control units 222 allow the client endpoints to interact with the presence service(s) provided by the presence server 204, including, for example, historical, and predictive services.

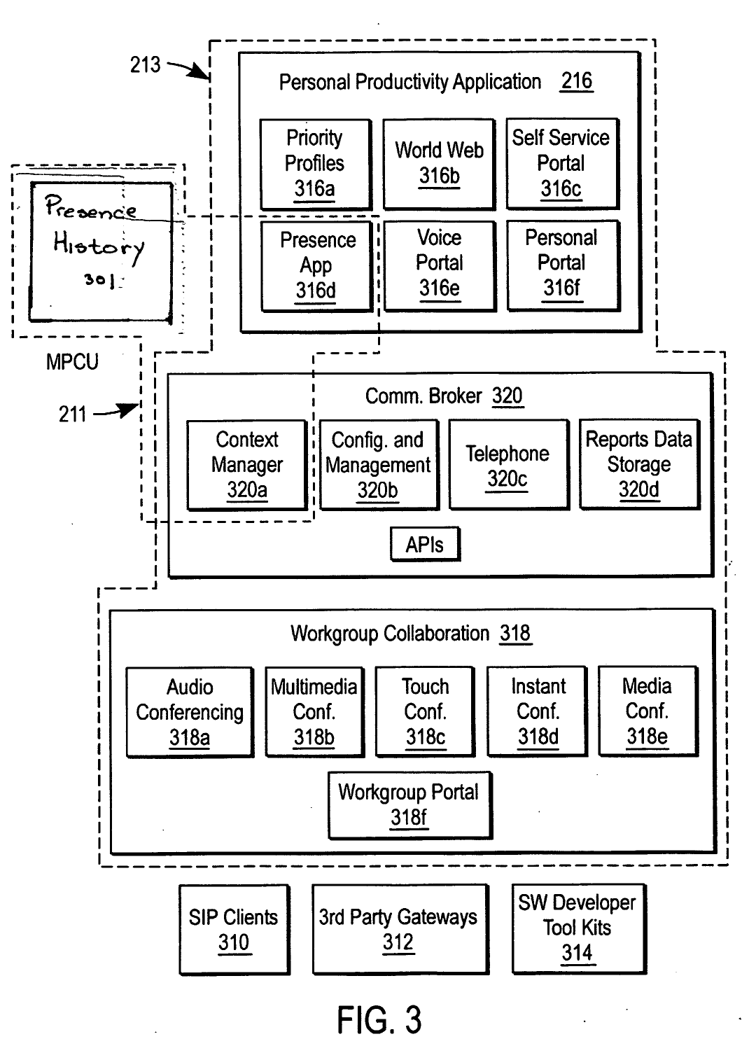

Turning now to FIG. 3, a block diagram illustrating a server 204 according to embodiments of the invention is shown. As shown, the server 204 implements a master presence control unit 211 and a server application suite 213. In the embodiment illustrated, the multimedia server 204 also provides interfaces, such as application programming interfaces (APIs) to IP phones/clients 310, gateways 312, and software developer toolkits 314. An exemplary server environment capable of being adapted for use in a system according to embodiments of the present invention is the OpenScape system, available from Siemens Information and Communication Networks, Inc. Such an environment can be implemented, for example, in conjunction with Windows Server, Microsoft Office Live Communications Server, Microsoft Active Directory, Microsoft Exchange and SQL Server. It is noted that the various control units discussed herein may be implemented as any suitable hardware, firmware, and software, or any combinations thereof.

As will be explained in greater detail below, the master presence control unit 211 collectively includes one or more presence history units, also referred to as historical presence control units (HPCU) 301, presence applications 316c, and a context manager 320a. In certain embodiments, personal profiles 316a interface to the master presence control unit 211, as well, and may be considered part of it. Thus, the master presence control unit 211 interfaces to productivity applications to provide presence services according to embodiments of the present invention.

In the embodiment illustrated, the application suite 213 includes a personal productivity application 316, a workgroup application 318, and a communication broker 320. The personal productivity application 316 implements various application modules: priority profiles 316a, word web 316b, presence 316c, voice portal 316d, self-service portal 316e, and personal portal 316f. The workgroup collaboration application 318 implements audio conferencing 318a, multimedia conferencing 318b, touch conferencing 318c, instant conferencing 318d, media advance 318e, and a workgroup portal 318f. The communications broker 320 implements a context manager 320a, configuration unit 320b, telephony features 320c, reports/data storage 320d, as well as interworking services.

The personal productivity portal 318f and workgroup portal 318f allow a user to access features using a standard Web browser, or via network application plugins.

The priority profiles 316a provide for handling of a user's communications and initiating specified actions, such as voice calls, e-mails and instant messages. It allows the user to configure personal rules for each status such as “In the Office”, “On Business Trip”, or “On Vacation;” and allows use of information such as who is calling and the media type to determine an action. The action may include routing to a specific device, routing to the preferred device at the time, sending a notification, and/or logging the transaction.

The presence application 316d functions as a contact list control unit and allows, through the use of the contact lists, monitoring the status of contacts (e.g., “In the Office,” “On Vacation,” “Working Remote,” etc.); and monitoring the “aggregated presence by media type” for each contact (i.e., whether the contact is accessible by phone, IM, or email).

The Word web 316b provides a Microsoft Word-based scripting for development of telephony applications. The self service portal 316c provides guest access to messaging, calendaring, and document retrieval features, such as Voicemail Functions—leave a message, transfer from voicemail; Calendar Functions—schedule/cancel/modify appointments with a subscriber, get email confirmation; and Document Access Functions—authenticate user based on PIN and allow reading, email or fax-back of documents stored in Exchange folders. The voice portal 316e provides user access to groupware features via the telephone. These can include, for example, Calendar Access functions—accept/decline/modify appointments, block out time; voicemail, email access functions—Inbox access with message sorting options (List total, retrieve (listen), skip, forward, reply, etc.).

In general, default user rules and actions are provided by the system users to specify custom rules and actions using the Personal Productivity Portal 316f, e.g., an interface to a client browser. During runtime, users can set their Presence State or specify a Preferred Device using either the Personal Productivity Portal 316f or the Voice Portal 316d.

The Workgroup Collaboration Portal 318f, which may be implemented as a browser interface, allows users to initiate audio or multi-media conferencing sessions and view documents that have been checked in to the Workgroup Repository (not shown). The audio conferencing module 318a and the multimedia conferencing module 318b allow the user to set up audio or multimedia conference sessions. The Instant Conference module 318d launches an audio or WebEx multimedia conferencing session, based on contact lists or address book(s). The Touch Conference module 318c allows the user to see the participant list and their presence status. The Media Advance module 318e offers users the point and click option to advance an existing audio conference to a multimedia collaborative session.

The communications broker 320 provides various communication services. The Context Manager 320a provides user presence/availability states for users, such as “In the Office”, “On Vacation”, “Working Remote”, etc.; and provides device presence and device context for both SIP registered devices and User defined non-SIP devices. In addition, the context manager 320a provides, across the set of devices for a user, aggregated presence by media type, e.g., voice, IM, and email. For example, if a user is accessible by any phone device such as an office phone, a home phone, or a mobile phone; the aggregated presence for the user would indicate accessibility via the media type “telephone.” Based on the aggregated presence information for each media type (e.g. available via telephone, not available via IM, available via email), others can choose the best medium of making contact with this user.

The telephony features 320c gives applications access to connection management features via CSTA (e.g. make a call, transfer call, set-up conference, etc.); provides address translation from dialing digits to SIP URL to broker connectivity between telephony devices and soft clients. The Interworking Services provide SIP gateway interworking (e.g., interworking with PSTN and PBX networks). Reports Data Storage 320d provides a repository for system and data reports.

The Context Manager 320a is a service that ties together a view of all users. This view may include the presence and availability of users, the state of users (e.g. in a voice call), each user's collaboration session associations, etc. The result is a detailed view of what the user and their devices are doing at any point in time. This information is used by other network users and system components to make decisions about how to contact the user, as will be described in greater detail below.

Collectively, the presence application 318c and context manager 320a operate in conjunction with the presence history unit 301 and priority profiles 316a to provide presence service according to embodiments of the present invention. In particular, as will be explained in greater detail below, the presence service operates to determine the history of predetermined contacts and undertake actions responsive thereto.

It is noted that, while a presence server in a unified messaging system is shown, the teachings of the present invention are equally applicable to a presence system associated with a single medium, such as Instant Messaging. Thus, the figures are exemplary only.

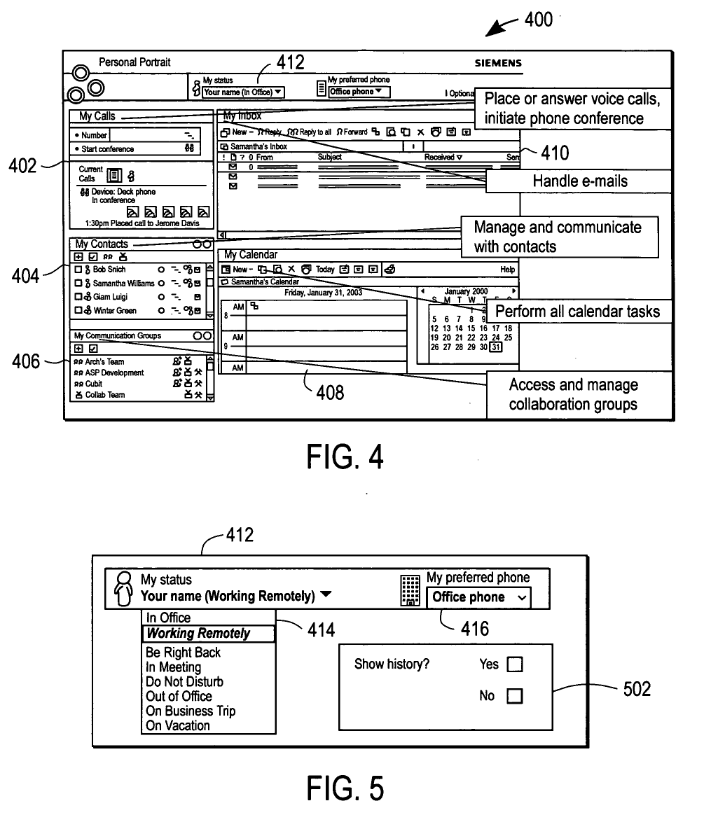

Turning now to FIG. 4, a diagram illustrating a graphical user interface personal portal 400 according to an embodiment of the present invention is shown. The GUI personal portal 400 may be a browser running on a client device that interacts with portal 316f (FIG. 3) and allows the user to handle communication tasks associated with applications 213 (FIG. 3), including, for example, handling voice calls, e-mails, and instant messages. In addition, the personal portal 400 allows the user to manage contacts and set history management. It is noted, that while a particular GUI is shown, any suitable interface could be employed, including, for example, a voice portal.

As shown in FIG. 4, the GUI personal portal 400 includes Calls window 402, Contacts window 404, Groups window 406, Calendar 408, Inbox 410, and User Status window 412. The Calls window 402 allows, for example, the user to enter a phone number and make a call the number; show current call status; and provides a call log. The Contacts window 404 allows the user to set one or more other parties as contacts and displays current contact status, including history information, as will be explained in greater detail below.

The Collaboration Groups window 406 similarly allows the user to display collaboration groups and status. The calendar window 408 allows the user to set times and dates, e.g., for making calls or setting meetings times. The Inbox window 410 permits receiving of e-mail or other multimedia messages. The user status window 412 allows the user to set current presence status.

In particular, FIG. 5 is a diagram illustrating an exemplary user status window 412. The user can use drop-down window 416 to set a preferred telephone or other communication medium, which is then received by personal profiles module 316a and can be provided to the master presence control unit 211. Current status can be set using drop-down 414. In the example illustrated, the user can set Current Status as In Office, Working Remotely, Be Right Back, In Meeting, Do Not Disturb, Out of Office, On Business Trip, or On Vacation. Once the client makes the settings, the settings are uploaded to the server.

In operation, users also can use their status portals 412 (FIG. 5) to select whether they want their presence history to be accessible to other users. Thus, for example, the GUI 412 of FIG. 5 provides an interface 502 for selecting Display History YES or NO. The associated command signaling is received at the historical presence control unit (HPCU) 301 to allow other user access, as will be explained in greater detail below.

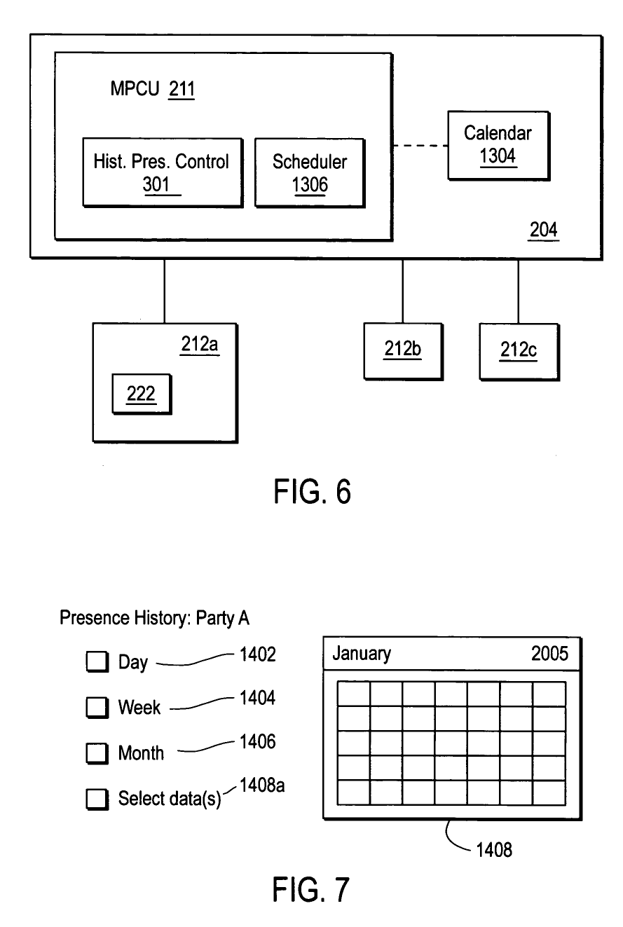

More particularly, as shown in FIG. 6, in certain embodiments, the server 204's master presence control unit 211 includes a historical presence control unit (HPCU) 301 that functions as a presence record unit and operates in conjunction with a calendar control unit or server 1304. An exemplary calendar control unit suitable for use with embodiments of the invention is the Microsoft Exchange server. These are accessible by the network client 212 via the presence control unit 222, which may include a suitable graphical user interface, such as a Web browser and/or one or more plug ins. For example, calendar 408 (FIG. 4) may be suitable. In addition, a scheduler 1306 may be provided, which receives the historical presence information, as well as user calendar information, to predict a future availability.

In operation, the historical presence control unit 301 operates in conjunction with the calendar 1304 to record the actual time and date of changes in party status. That is, the historical presence control unit 301 maintains one or more parties' presence histories in associated memory (not shown). This information record can then be provided to other users, i.e., be made available in a presence map or calendar format to other users. For example, the server can provide the data to be displayed or generated locally in a web type browser as a presence map or calendar.

Other users can access another party's presence history by clicking on one or more menu buttons, for example, when a particular party is highlighted in the user's contact list 404 (FIG. 4). In the embodiment illustrated in FIG. 7, an interface specific to the selected party will be displayed; the user then has the option of selecting whether to view day 1402, a week 1404, or month 1406. In other embodiments, as shown at 1408a, 1408, the user can select a date or a range of dates for historical presence display.

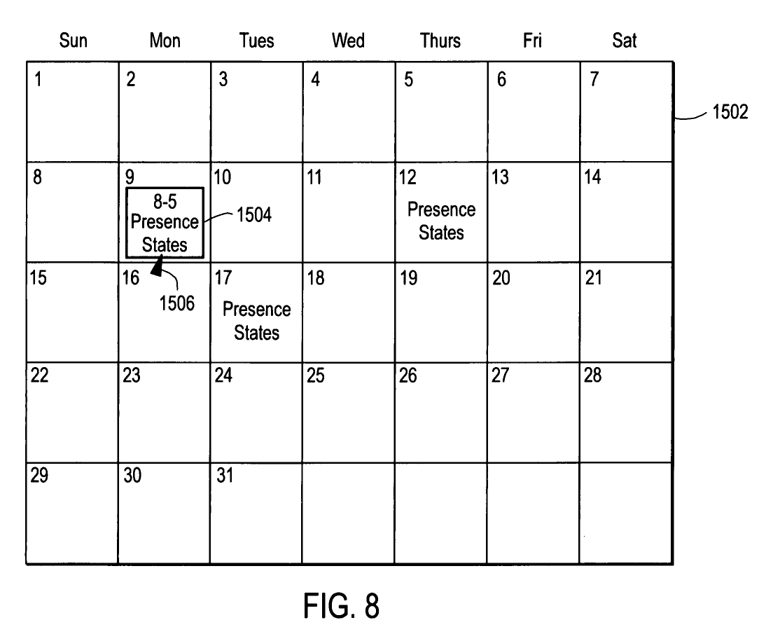

If, for example, the user clicks on Month 1406, a month display 1502 such as shown in FIG. 8 can be generated. In certain embodiments, each date will have one or more presence status displayed. Different conditions, such as presence state or media, can be displayed using different colors, for example. If more than one historical presence status is associated with a particular day, then the user can then select a day 1504, for example, by scrolling cursor 1506 over it. The presence status can then be shown in an enlarged display.

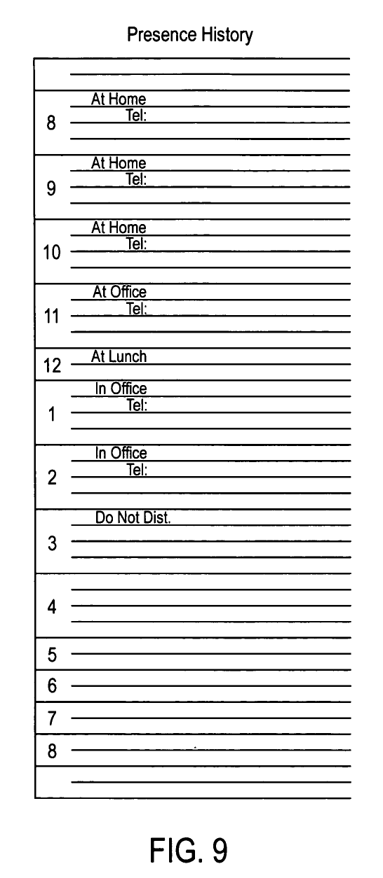

A particular day can be selected, e.g., by using the GUI of FIG. 7 or, for example, by double clicking a day on the month calendar of FIG. 8. An exemplary day status display is shown in FIG. 9. In the example illustrated, a twelve hour display is shown, from 8 AM to 8 PM, in hourly increments. Availability can be displayed according to color or textually. For example, as shown, the party is At Home from 8 AM to 10 AM; in the office from 11 AM to 12 PM; at lunch from 12 to 1; and at work again from 1 to 3 PM and has set 3 PM to Do Not Disturb. In certain embodiments, a default entry during daytime or work hours may be “available at work;” similarly, during non-daytime or work hours may be “unavailable.”

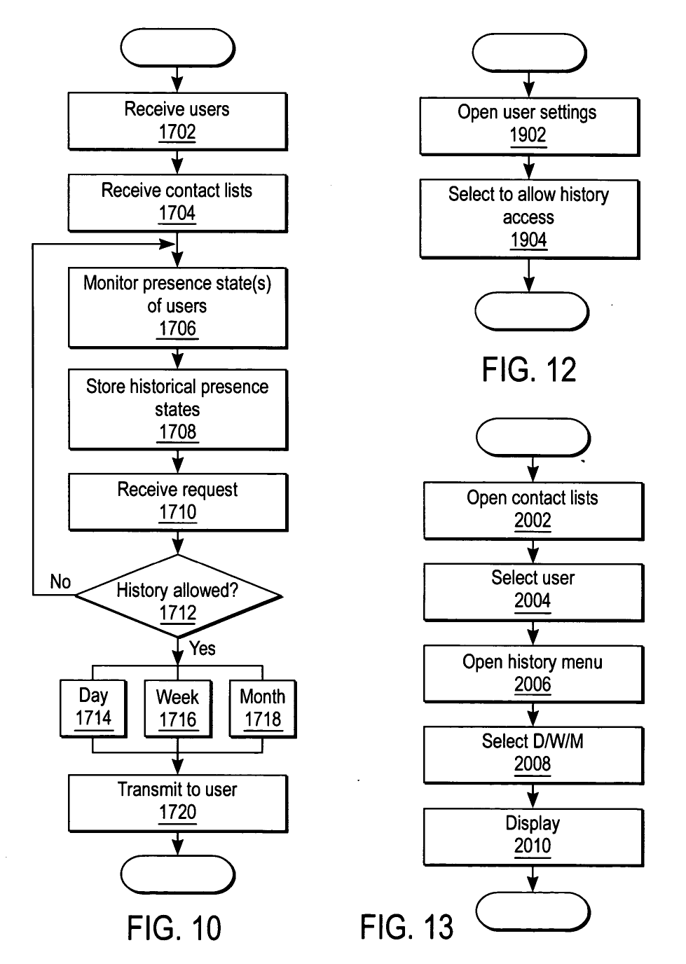

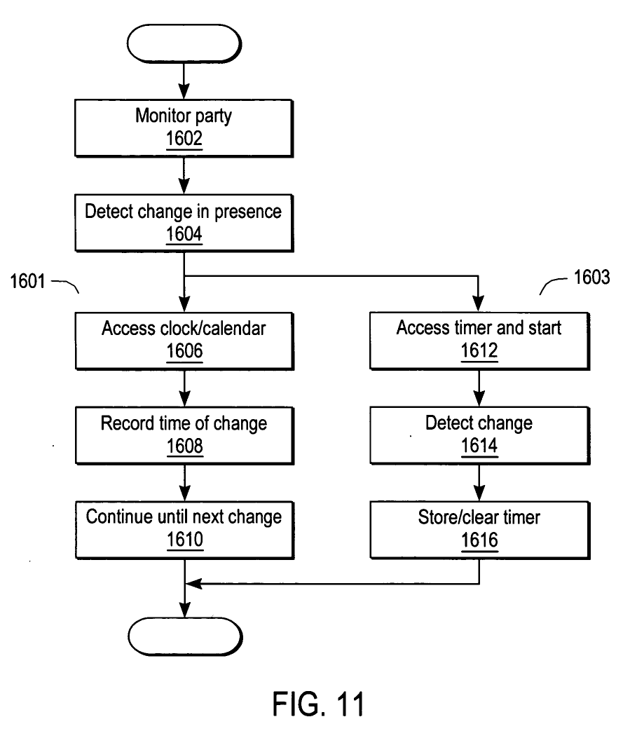

Turning now to FIG. 10, a flowchart illustrating operation of an embodiment of the invention is shown. In particular, the flowchart of FIG. 11 illustrates server operation according to an embodiment of the present invention. Initially, at a step 1702, the server is initialized or configured with the registered users. This may be accomplished, for example, by a system administrator using a browser interface. Once the users have been registered, the server 204 and, particularly, the master presence control unit 211, is set up to receive user contact lists and personal preferences, as shown at step 1704. At step 1706, the master presence control unit 211 monitors the presence status of the registered users and, particularly, those on received contact lists. That is, the master presence control unit 211 can record the time and dates of presence status and changes for registered users. In step 1708, the master presence control unit 211's historical presence control unit 301 stores the historical presence information, along with time and date indicia, in one or more databases (not shown). As noted above, when a presence change occurs, the master presence control unit 211 and, particularly, the historical presence control unit 301 can access the calendar 1304 and/or access the real time clock 1309 to determine the time and date of a presence change and store it in one or more memory locations assigned to the party.

At step 1710, the master presence control unit 211 can receive a user request for a party's historical presence information. For example, as discussed above, such a request can be received using a suitably programmed web interface and can be customized to media or state. Once the request has been received, the master presence control unit 211's historical presence control unit 301 checks to determine if the requested party has chosen to allow his presence history to be accessed, as shown at step 1712. Such permission may be associated with all users or only particular users. If permission is not allowed, the master presence control unit 211 will continue monitoring, as shown at 1706. If permission is given, then at step 1714, 1716, 1718, the historical presence control unit 301 will access past day, week, or month (or user-specified day, week, or month, or combinations thereof. Finally, at step 1720, the presence information is provided to the requesting user as a calendar map. The map can be customized to display presence media or states in different colors, etc.

FIG. 11 illustrates in greater detail server recording the historical presence state of the corresponding parties. In a step 1602, the master presence control unit 211 monitors the parties' presence states. At step 1604, the master presence control unit 211 detects a change in a selected party's presence state. Then, depending on the implementation, the server can-proceed along branch 1601 or 1603.

If branch 1601 is implemented, then in step 1606, the historical presence control unit 301 accesses a system clock and/or calendar 301 and, at step 1608, records the time and date of the change in presence state. Then monitoring continues at step 1610 until the next change in presence state is detected.

If branch 1603 is implemented, then in step 1612, after a change in presence state is detected at step 1604, a timer is started at step 1612. A next change in presence state is detected at step 1614. In a step 1616, the timer entry is stored, the timer itself is cleared, and begins timing again until the next change in presence status for the party is determined. In this embodiment, the amount of time at a given presence state can thus be directly determined. Alternatively, of course, the amount of time could be calculated from the exact hour, minute data determined using branch 1601. As will be explained in greater detail below, such information may be useful in predicting whether a party will be available on a particular date.

FIG. 12 and FIG. 13 illustrate operation of an embodiment of the present invention on the client side. Turning now to FIG. 12, at a step 1902, the user can open a settings menu using his graphical user interface. As noted above, the graphical user interface can be implemented as a web page or browser page provided by the server 204. The user then selects whether to allow other party access to his presence history, in step 1904. As noted above, this can be universal permission or party-specific permission. A default may be no permission.

In operation, as shown in FIG. 13, a user can open his contact list(s), in step 2002. In a step 2004, the user can select a party from the contact list, e.g., by highlighting or double-clicking the corresponding entry. At 2006, the user may open a history menu (FIG. 7). The history menu allows the user to select a day, week, month, or other time period, or a date or time range for viewing the particular party's presence history, as seen at step 2008. In addition, in certain embodiments, the presence state and media can be specifically set; a default would be to display all media and states. Finally, at step 2010, the presence history may be displayed for the user, as discussed above.

As noted above, one aspect of embodiments of the present invention is determining an availability of a party and scheduling a communication, such as an audio or multimedia teleconference. As will be explained in greater detail below, in operation, a scheduler 1306 (FIG. 6) accesses the party history to make a prediction of when the party is available, and can access the calendar to schedule the conference. In certain embodiments, the scheduler 1306 determines a next best available time or one or more next best available times for contacting the other party.

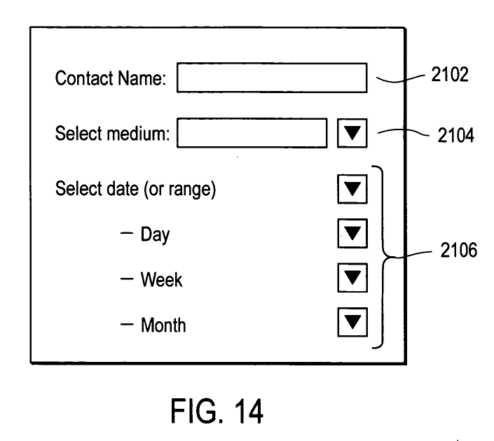

A graphical user interface that allows the user to select various scheduling parameters is shown in FIG. 14. The GUI of FIG. 14 may be implemented as a browser window or windows capable of sending form data to the server. Once the user has accessed his contact list, he can select a particular contact (or enter a contact name) 2102. The user can also select a contact medium using menu 2104. That is, the user can select a media constraint, i.e., whether to contact the other party via telephone, IM, or the like. The user can then use menu 2106 to select a day, time or range of dates and times, that would be preferred for the contact. In operation, the information is received at the server, which accesses the party history and also, in certain embodiments, the party calendar, to make the prediction of availability and schedule the user call.

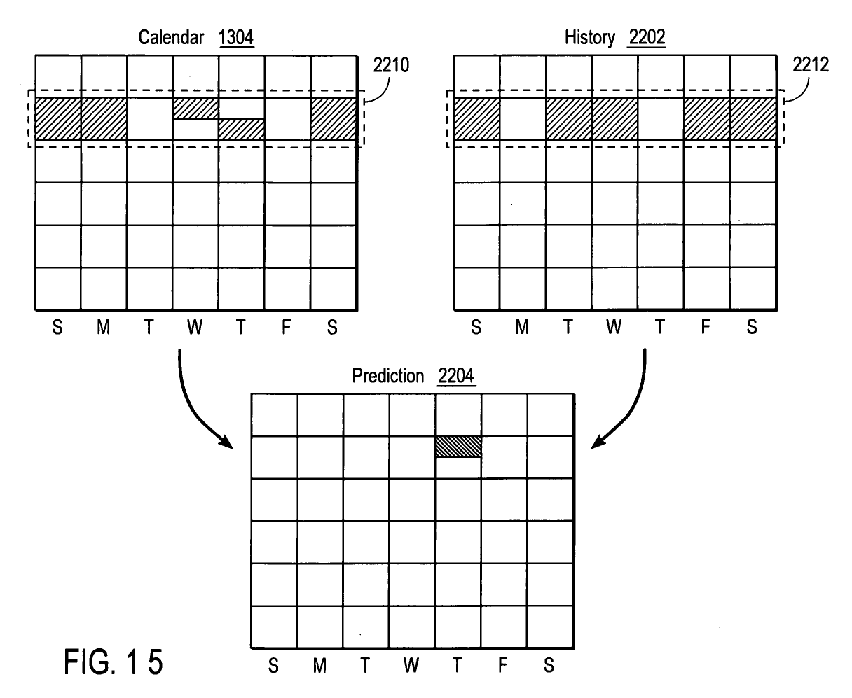

One example of this predictive scheduling is shown with reference to FIG. 15. In the example illustrated, it is assumed that the user has chosen to attempt to schedule a call with a party for “Next week.” In response, the scheduler 1306 (FIG. 8) will access a history 2202 and, in certain embodiments, also a calendar 1304. The history 2202 may yield a history of availability of a corresponding week 2212. For example, the week could be a most recent (last) week; or the same week last month (or year), or an “average” (i.e., a cumulative summation) of a past predetermined number of weeks. As shown, the party shows a past availability on Monday and Thursday. In certain embodiments of the present invention, the scheduler 1306 would then attempt to schedule the user to make the call sometime Monday or Thursday. However, in other embodiments, the scheduler 1306 also has access to the party's calendar 1304 for the period in question. In the example illustrated, the calendar shows 1304 a week 2210 and indicates that the party has an availability on Tuesday, Thursday morning, and Friday. The scheduler 1306 thus schedules the call for Thursday morning, as shown at 2204. The scheduler 1306 can display a web page or browser window that shows the calendar and available time to the user. The user may then be given the option of entering the appointed time on his calendar, and also transmitting a request to the other party. It is noted that, while not illustrated, in a similar fashion, embodiments of the present invention can also use the user's history and calendar (as well as the other party history and calendar) as constraints on the schedule.

As will be discussed below, “availability” on a particular day can include an actual hour-by-hour analysis of the days of the week. In other embodiments, however, the system may determine that the user is not available at a given day if he has been unavailable for more than, for example, four hours during the day in the past. Similarly, the party may be deemed unavailable during half days if the user has in past not been available more than an hour in each half day. Such a determination may be made, for example, using the timer as described above.

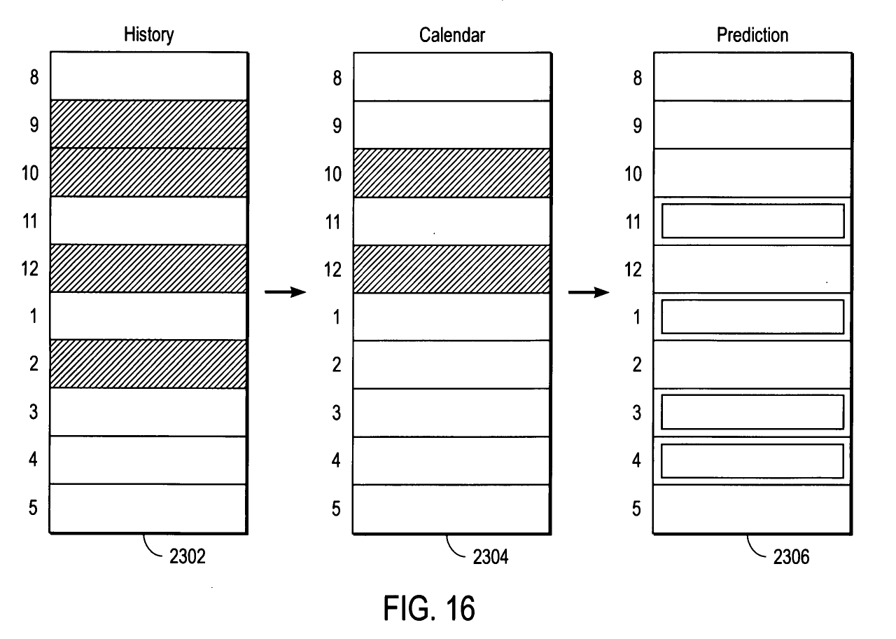

FIG. 16 illustrates scheduling and/or analysis on a particular day. That is, in this example, the user has selected to determine whether a call can be scheduled for a particular day. Thus, at 2302, the scheduler 1306 pulls up the user history for a particular day. Similar to the week scheduling discussed above, the history can be for yesterday, the same day last week, or an average of most recent days or same days during previous weeks. In the example illustrated, the party is available at 8 AM, 11 AM, 1 PM, and 3-5 PM. This embodiment also can access the party calendar 1304, as shown at 2304. As can be seen, on the days requested, the party is available from 8 AM to 10 AM; at 11 AM; and from 1 PM to 5 PM.

Thus, the scheduler 1306 determines that the party is available at 11 AM, 1 PM, and from 3 to 5 PM. The scheduler 1306 can then request a call with the other party, or simply indicate to the user when that party is available. In addition, in certain embodiments, the scheduler 1306 can also access the user's own calendar and history to constrain the availability determination.

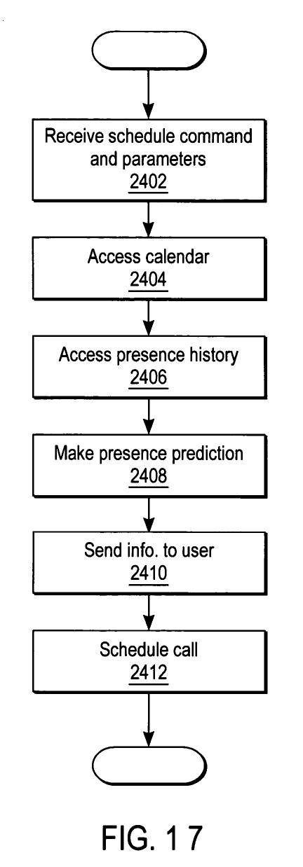

FIG. 17 is a flowchart illustrating operation of an embodiment of the present invention. Initially, in a step 2402, the master presence control unit's scheduler 1306 can receive the schedule command and associated parameters (i.e., party, date or range of dates desired, medium, and the like). At a step 2404, the scheduler 1306 can use the party information to access the party's calendar 1304. Similarly, the information can be used to access the party's presence history, in a step 2406. The scheduler 1306 then uses the availability, etc., information to make a presence prediction, in a step 2408. The presence prediction may include one or more times and dates. As noted above, the presence prediction can also take into account the user's own history and calendar. Next, in a step 2410, the schedule information is provided to the user, e.g., via a web page interface. The user can then select which of the options to schedule the call, in step 2412. This information can then be scheduled in his calendar. It is noted that, while discussed in terms of a call to a single other party, the present invention is equally applicable to scheduling a conference among several parties; in this case, a common period of availability (both past and future) may be defined for all parties.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description were chosen in order to explain the principles of the invention and its practical application. The drawings are not necessarily to scale and illustrate the device in schematic block format. It is intended that the scope of the invention be defined by the claims appended hereto, and their equivalents.

What is claimed is:

1. A telecommunications system, comprising:
a network;
a plurality of client devices operably coupled to said network, said plurality of client devices adapted to select one or more of others of said plurality as contacts on a contact list;
a presence server coupled to said network and adapted to monitor presence status of selected ones of said others, wherein said presence server maintains one or more records of past presence data for said selected ones;
a calendar server adapted to maintain a calendar for selected ones of said plurality; and
a scheduler adapted to receive said one or more records and said calendar and determine a likely presence status at a predetermined time.

2. A telecommunications system in accordance with claim 1, wherein said scheduler adapted to assign a prediction score to one or more of said records and determine said likely presence state by optimizing said prediction score.

3. A telecommunications system in accordance with claim 1, wherein said scheduler is adapted to receive a plurality of calendars and a plurality of records and determine an optimal time to schedule a communication for each party associated with the records and calendars.

4. A telecommunications system in accordance with claim 1, wherein said presence server is adapted to receive authorization for other parties to download a presence history of a particular party.

5. A telecommunications system in accordance with claim 1, wherein said scheduler is adapted to provide said likely presence status via a browser interface.

6. A telecommunications system, comprising:
a network;
a plurality of client devices operably coupled to said network, said plurality of client devices adapted to select one or more of others of said plurality as contacts on a contact list;
a presence server coupled to said network and adapted to monitor presence status of selected ones of said others, wherein said presence server maintains one or more records of past presence data for said selected ones; and
means for predicting an availability of one or more of said plurality based on said one or more records.

7. A telecommunications system in accordance with claim 6, said predicting means further including calendar means for accounting for previously scheduled availability when making said prediction.

8. A telecommunications system in accordance with claim 7, wherein said predicting means includes means for authorizing a party to access said one or more records of other parties.

9. A telecommunications system in accordance with claim 6, wherein said predicting means predicts a best next available time.

10. A telecommunications system in accordance with claim 9, wherein said predicting means predicts a plurality of next available times.

11. A telecommunications system in accordance with claim 4, wherein said predicting means predicts a next available time based on a media constraint.

12. A telecommunications method, comprising:
maintaining a list of users whose presence is monitored;
maintaining a record of past presence status of said user; and
predicting a future presence status of said user based on said record.

13. A telecommunications method in accordance with claim 12, wherein said predicting comprises predicting a next best available period.

14. A telecommunications method in accordance with claim 12, wherein said predicting is constrained by an existing calendar of availability for said user.

15. A telecommunications method in accordance with claim 12, wherein said predicting comprises predicting a common period of availability for a plurality of users.
